(19) United States
(12) Patent Application Publication
(10) Pub. No.: US 2026/0237825 A1
(43) Pub. Date: Aug. 13, 2026

(54) ENERGY STORAGE ARRANGEMENT

(71) Applicant: Carl Freudenberg KG, Weinheim (DE)

(72) Inventors: Armin STRIEFLER, Rimpar (DE); Reiner DIRR, Munich (DE); Peter KRITZER, Forst (DE)

(21) Appl. No.: 19/470,841

(22) PCT Filed: Mar. 27, 2024
(86) PCT No.: PCT/EP2024/058297

§ 371 Date: Sep. 30, 2025

(30) Foreign Application Priority Data
Apr. 3, 2023 (DE) 10 2023 108 407.0

(51) Int. Cl. H01M 50/278; H01M 10/653; H01M 10/6551; H01M 50/342; H01M 50/367; H01M 50/507

(52) U.S. Cl. CPC H01M 50/278; H01M 10/653; H01M 10/6551; H01M 50/3425; H01M 50/367; H01M 50/507

(57) ABSTRACT

An energy storage arrangement (1), comprising a plurality of energy storage cells (2) which each have electrical poles (3) and at least one emergency opening (4), at least one covering element (5) which covers the electrical poles (3) and has openings (6) which are associated with the emergency openings (4) being arranged on the energy storage cells (2).

### CROSS REFERENCE TO RELATED APPLICATIONS

This application is a U.S. National Phase application under 35 U.S.C. § 371 of International Application No. PCT/EP2024/058297, filed on Mar. 27, 2024, and claims benefit to German Patent Application No. DE 10 2023 108 407.0, filed on Apr. 3, 2023. The International Application was published in German on Oct. 10, 2024 as WO 2024/208699 A 1 under PCT Article 21(2).

### FIELD

The invention relates to an energy storage arrangement comprising a plurality of energy storage cells, each of which has electrical terminals and at least one safety vent.

### BACKGROUND

Energy storage cells with safety vents are known, for example, from EP 3 128 579 A1. Energy storage arrangements, in particular rechargeable storage devices for electrical energy, are widely used, especially in mobile systems.

Rechargeable energy storage cells for electrical energy are used, for example, in portable electronic devices such as smartphones or laptops. Furthermore, rechargeable energy storage devices are used to provide energy for electrically powered vehicles. The range of electrically powered vehicles extends from passenger cars to two-wheelers, small vans, and trucks.

Applications in robots, ships, aircraft, and mobile machinery are also conceivable. Other areas of application for electrical energy storage devices include stationary applications, for example, for uninterruptible power supply in IT systems, in network stabilization systems, and for storing electrical energy from renewable energy sources.

A frequently used energy storage system is based on energy storage devices in the form of lithium-ion batteries. Like other rechargeable energy storage devices, lithium-ion batteries usually have several storage cells that together form a module. In addition to lithium-ion accumulators, lithium-sulfur batteries, solid-state batteries, sodium-ion batteries, batteries based on other light metals such as magnesium or aluminum, and metal-air batteries are also being considered.

Electrical energy storage devices exhibit their highest electrical capacity as well as optimal power input and output only within a limited temperature range. If the temperature exceeds or falls below the optimal operating temperature range, the capacity, power intake capability, and power output capability of the storage device decrease significantly, and the functionality of the energy storage device is impaired. Excessively high temperatures can also cause irreversible damage to the energy storage device. Accordingly, sustained elevated temperatures and short-term temperature peaks should be avoided. For example, lithium-ion batteries should not be exposed to sustained temperatures of more than 50° C. or short-term temperature peaks of more than 80° C.

Particularly for use in passenger cars or commercial vehicles, energy storage devices are required to have fast-charging capabilities. Thereby the energy storage devices should be fully or nearly fully charged within a short period of time, for example within 15 minutes. Due to the efficiency of the charging system, which ranges between a maximum of 90% to 95%, large amounts of heat are released during the charging process in the energy storage arrangement, which must be dissipated from the energy storage arrangement. Therefore, it is generally necessary to regulate the temperature of the energy storage arrangements.

Excessive temperatures, internal and external short circuits, or mechanical damage to the cells can cause irreversible damage to the energy storage devices. In this context, thermal runaway is a particularly well-known phenomenon in lithium-ion batteries. This involves the rapid release of large amounts of thermal energy and gaseous reaction products, resulting in high pressure and high temperatures inside the housing of an energy storage cell. For this reason, energy storage cells usually have safety vents through which excess pressure can be released. Due to the development of energy storage devices with high energy density, as required for providing electrical energy in electrically powered vehicles, the release of gases in the event of a malfunction is also significantly increased. To release excess pressure, energy storage cells with a metal housing can be equipped with a safety vent, which can be configured in the form of a rupture disk, for example. In the event of damage, the pressure and temperature inside an energy storage cell rises sharply, whereby the safety vent opens when a specified pressure is exceeded, for example by breaking the rupture disk, and harmful gases can escape from inside the energy storage cell. The safety vent prevents the energy storage cell from opening uncontrollably and exposing neighboring energy storage cells to excessive thermal and mechanical stress. During thermal runaway, hot gases with temperatures that can exceed 1,000° C., depending on the cell chemistry used, as well as electrically conductive particles are ejected from a safety vent. These include, for example, carbon particles or metallic or metal oxide particles or metallic melting products.

However, the problem here is that electrically conductive particles can accumulate on electrical connectors or contacts of the energy storage cells. It is possible that the connectors or contacts could be short-circuited by particles escaping from the interior of an energy storage cell. The problem here is that the released particle flows cause very high thermal and abrasive stresses. Simple insulation materials such as plastic housings or heat shrink tubing can be damaged and expose the underlying electrical structures.

This poses the risk of thermal runaway in other energy storage cells. The release of gases or particles from a cell that has undergone thermal runaway can cause a short circuit in another cell in the energy storage system.

### SUMMARY

In an embodiment, the present disclosure provides an energy storage arrangement including a plurality of energy storage cells which each have electrical terminals and at least one safety vent. At least one covering element is arranged on the plurality of energy storage cells, covers the electrical terminals, and has openings that are assigned to the safety vents.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts an energy storage arrangement in an exploded view in accordance with embodiments of the present disclosure;

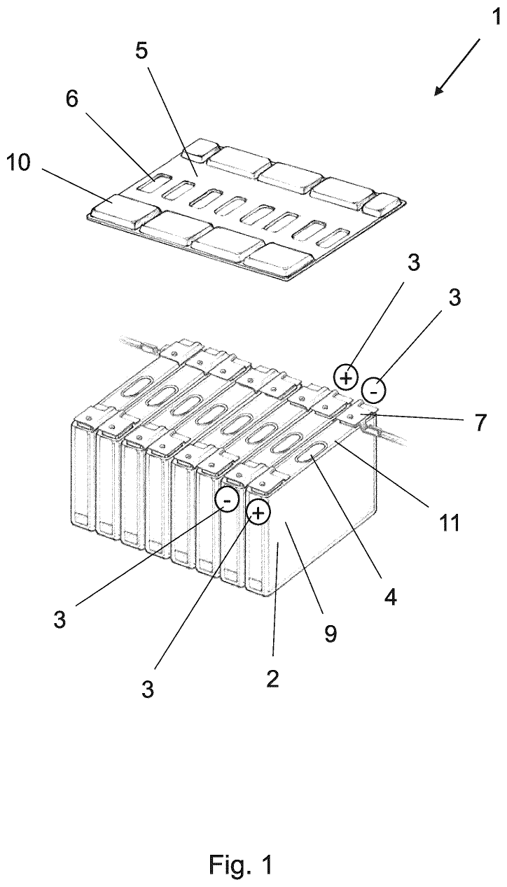

FIG. 2 depicts a detailed view of a first embodiment of a cover element of the present disclosure;

FIG. 3 depicts a second embodiment of a cover element of the present disclosure;

FIG. 4 depicts a third embodiment of a cover element of the present disclosure;

FIG. 5 depicts a fourth embodiment of the cover element of the present disclosure;

FIG. 6 depicts a unit consisting of cover element and cell connector in an exploded view in accordance with embodiments of the present disclosure;

FIG. 7 depicts a cover element with associated heat sinks in accordance with embodiments of the present disclosure;

FIG. 8 depicts a cover element with an associated blow-off channel in accordance with embodiments of the present disclosure; and

FIG. 9 depicts an exemplary configuration of the discharge channel.

### DETAILED DESCRIPTION

Embodiments of the present disclosure provide an energy storage arrangement that has a high level of operational safety.

The energy storage arrangement according to embodiments of the present disclosure comprises multiple energy storage cells, each having electrical terminals and at least one safety vent, wherein at least one cover element is arranged on the energy storage cells, which covers the electrical terminals and has openings that are assigned to the safety vents.

The cover element covers the electrical terminals in such a way that the electrical terminals are better protected from external influences and that no electrically conductive particles can accumulate on the electrical terminals. This applies in particular to electrically conductive particles that can escape from the interior of an energy storage cell in the event of damage. Through the opening incorporated in the cover element, it is ensured that in the event of damage, the overpressure within an energy storage cell can be safely released. Harmful gases are thereby released through the safety vent and carried away from the energy storage cells. The cover element protects the terminals of the energy storage system from the effects of electrically conductive particles and prevents the deposition of harmful gases and the particles carried along with the gases on the electrical terminals.

The cover element can furthermore be configured to withstand hot and abrasive particle flows. When the cover element comes into contact with such particle flows, the cover element does not melt, nor are electrically conductive thermal degradation products formed. Thermoplastic materials, for example, can be used for this purpose. In an embodiment of the present disclosure, carbon-based polymers or thermosets can also be considered, in which electrically conductive carbon structures are formed by pyrolysis processes.

The energy storage cells can be configured as prismatic cells.

Prismatic cells have a rectangular housing in which an electrode unit is arranged, wherein the housing is closed by a cover. The electrical connection of the energy storage cell is made via the electrical terminals, which are usually arranged in the cover. The safety vent can be located between the two electrical terminals in the cover.

Prismatic cells can be arranged side by side in a space saving manner.

Adjacent energy storage cells can be electrically connected to each other via at least one cell connector. Such interconnected energy storage cells form a module, whereby depending on the electrical connection, either an increase in electrical voltage or an increase in capacity is possible. Within the energy storage arrangement forming a module, the energy storage cells are preferably connected in series so that the electrical voltage of the energy storage arrangement is increased. In the case of a lithium-ion battery, the electrical voltage of a single energy storage cell is approximately 3.6 volts, and the electrical voltage can be significantly increased by connecting several energy storage cells in series. In addition, several modules are connected, each containing energy storage cells connected in series, in parallel.

In the case of series connection, a cell connector covers one terminal of opposite polarity on two adjacent energy storage cells. Thereby it is important to avoid electrical contact between adjacent cell connectors, as this would lead to a short circuit. This is particularly problematic in the event of damage, as the distance between adjacent cell connectors is particularly small. However, the cover element provides reliable electrical insulation between adjacent cell connectors, so that a short circuit can be avoided even in the event of damage.

Preferably, the cover element covers the cell connectors. This ensures that no electrically conductive particles or the like can accumulate on the cell connectors, which could cause adjacent cell connectors to connect electrically in an undesirable manner and lead to a short circuit.

The opening incorporated into the cover element can be configured as a breakthrough that can be aligned with the safety vent of an energy storage cell, whereby the opening is preferably configured to be congruent with the safety vent. Preferably, the breakthrough is configured relative to the safety vent in such a way that unobstructed release of harmful gases, particles, and the like is possible in the event of damage. With the aid of the safety vent, the substances released from the cell can be directed to a side of the cover element that faces away from the cell connector.

The opening associated with the cover element may have at least one slit. As a result, the cover element is essentially closed during normal operation, so that the energy storage cells are particularly well protected against external influences, which is particularly advantageous with regard to condensate formation. The slits can be configured in the form of a longitudinal slit, a cross slit, a semicircular slit, or the like.

In an embodiment of the present disclosure, a predetermined breaking point is assigned to the opening, for example in the form of a notch or material weakening incorporated into the cover element.

The cover element is preferably made of electrically insulating and thermally conductive material. Furthermore, the cover element is preferably made of elastic, in particular elastomeric material. The elastic configuration allows the cover element to adapt to the shape of the energy storage cells, the electrical terminals, and/or the safety vents, and the cover element seals at least the cover region of the energy storage cells.

The cover element is preferably made of a thermally stable elastomer. In this context, silicone materials and fluorinated silicone materials are used. Silicone-based elastomers are particularly preferred because they do not form electrically conductive structures even when thermally degraded. Furthermore, the use of fluororubbers or materials based on EPDM or EVA is also included in embodiments of the present disclosure.

The dielectric strength of the cover element is at least 2 k V/mm. The cover element is also preferably flame-resistant. The cover element may be provided with endothermically effective fillers and have fiber reinforcement.

The cover element may be thermally conductive. Improved thermal conductivity can be achieved, for example, by adding hydroxides, oxides, or nitrides. Due to the improved thermal conductivity, heat can be distributed over the entire cover element in the event of a malfunction, thereby reducing local thermal stress in the region of the opening. Furthermore, a thermally conductive configuration can contribute to improved heat dissipation during normal operation and transfer heat from the cell connectors to the cover element. Preferably, the thermal conductivity of the material of the cover element is at least 0.5 W/(m·K).

The cover element may be connected to the energy storage cells in a material-locking manner. Thereby, the cover element is connected to the energy storage cells via an adhesive bond. In an embodiment of the present disclosure, the cover element is formed directly onto the energy storage cells. This is particularly advantageous when using adhesive elastomeric materials.

In an embodiment of the present disclosure, the cover element forms a unit with the cell connectors. The cell connectors can thereby be embedded in the cover element, or the cover element can be formed directly onto the cell connectors. In both cases, the shape of the cover element can be configured to ensure that adjacent cell connectors are electrically isolated from each other and that the electrical insulation is maintained even in the event of a malfunction. In an embodiment of the present disclosure, the cell connectors have already been overmolded by the cover element in advance.

At least one heat sink can be assigned to the cover element. In particular, when the cover element is thermally conductive, it is possible to cool the energy storage cells via the terminals. This allows the anodes and cathodes inside the cell housing to be cooled particularly effectively when the terminals are cooled. Placing the cooling elements above the cells is advantageous because energy storage cells are particularly easy to access via the cover region. A particularly good cooling effect is achieved when a heat sink is assigned to the cell connectors. Electrical contact to the terminals is made via the cell connectors, wherein the terminals are electrically conductively connected to the electrode unit. These components usually also exhibit very good thermal conductivity, so that cooling associated with the electrical terminals is particularly effective. Until now, the problem has been that the cooling can accelerate the formation of condensate. However, the cover element located between the heat sink and the electrical terminals prevents condensate from directly depositing on the electrical terminals. Condensate on the cover element, on the other hand, is not a problem.

Embodiments of the energy storage arrangement according to the present disclosure are explained in more detail below with reference to the figures.

The figures show an energy storage arrangement 1 comprising several energy storage cells 2 in the form of prismatic cells. The energy storage cells 2 each have a housing 9 which is closed by a cover 11. The two electrical terminals 3 of a cell are assigned to the cover 11, wherein the terminals 3 are assigned to the narrow sides of the housing 9. Between the two terminals 3, a safety vent 4 is incorporated into the cover 11. The safety vent 4 comprises a breakthrough formed in the cover 11, which is closed by a rupture disk.

Adjacent energy storage cells 2 are electrically connected to each other by a cell connector 7 in such a way that the energy storage cells 2 arranged in the energy storage arrangement 1 are connected in series. The cell connectors 7 are made of electrically conductive metallic material and are manufactured as stamped parts from a planar element. Copper and aluminum are particularly suitable materials for this purpose. A cell connector 7 thereby covers two terminals 3 and connects one terminal of an energy storage cell 2 to an oppositely charged terminal of an adjacent energy storage cell 2. Accordingly, it is necessary to electrically isolate adjacent cell connectors 7 from each other. In normal operation, this can be ensured by spatial separation. However, if conductive substances or water enter the space between adjacent cell connectors 7, leakage currents or short circuits may occur. Further insulation is provided in this case by a cover element 5. The cover element is made of elastomeric material, in this case silicone. The cover element 5 is electrically insulating and thermally conductive. The cover element 5 covers the electrical terminals 3 of the energy storage cells 2. In the regions of the cover element 5 assigned to the safety vents 4, an opening 6 is provided in the cover element 5 so that, in the event of damage, material flowing out of the safety vents 4 can escape through the opening 6. The material thereby reaches the side of the cover element 5 facing away from the cell connectors 7 and is thus spatially separated from the cell connectors 7.

In the present configuration, the cover element 5 seals the energy storage cells 2 in the region of the covers 11 in such a moisture-tight and water-tight manner that any condensate that may form cannot lead to moisture precipitation in the region of the electrical terminals 3. In addition, the cover element 5 also seals the space between the energy storage cells 2 so that no released material can enter the space.

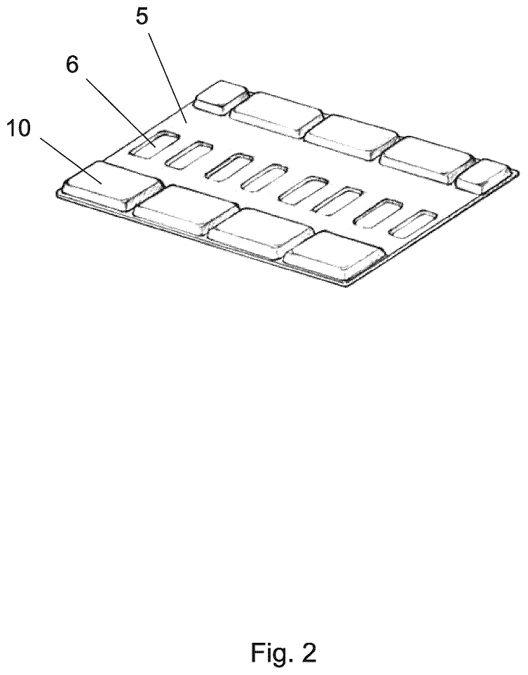

FIG. 2 shows a cover element 5 in detail. The cover element 5 has several openings 6 in the middle region, which are assigned to the safety vents 4 of the energy storage cells 2. In the edge regions, the cover element 5 includes elevations 10, whereby the elevations 10 are configured to accommodate the cell connectors 7. Each cell connector 7 is assigned an elevation 10, so that adjacent cell connectors are electrically isolated from each other by the wall of the adjacent elevations 10.

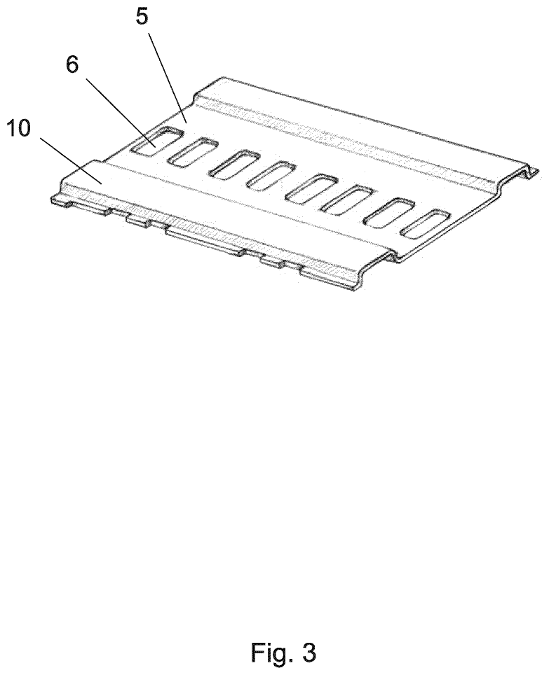

FIG. 3 shows an alternative configuration of the cover element 5 described in FIG. 2. In this configuration, channel-shaped elevations 10 are formed on both edges of the cover element 5, with each elevation 10 accommodating the cell connectors 7 arranged on one side of the housing 9. This configuration allows for a particularly flexible arrangement of the cover element 5. In addition, the cell connectors 7 arranged below the cover element 5 can have different shapes and lengths. Such a configuration of the cover element 5 can be extruded as a profile, which is advantageous for arrangements with a particularly large number of energy storage cells 2.

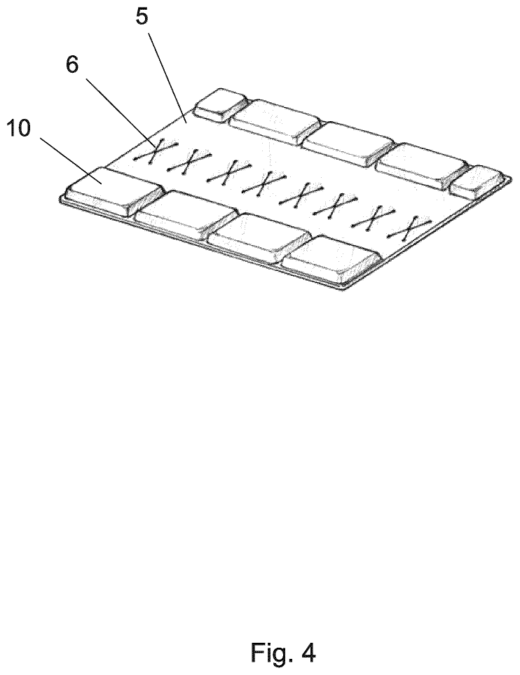

FIG. 4 shows an alternative configuration of the cover element 5 described in FIG. 2. In the present configuration, the openings 6 exhibit cross-shaped slits. In the event of damage harmful gases escape through the safety vents 4 and can escape through the slits in the opening 6. The opening 6 can open along the slits, thereby enlarging the passage opening. During normal use of the energy storage arrangement 1, in the present embodiment, the openings 6 are essentially closed by the opposing walls of the slits abutting each other. This configuration ensures that upon release of material from an opening 6, the openings 6 of intact, adjacent energy storage cells 2 are protected.

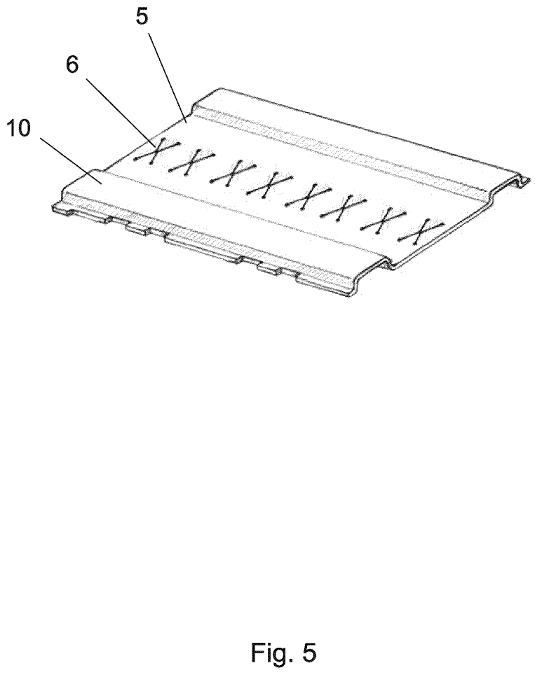

FIG. 5 shows an exemplary embodiment of the cover element 5 shown in FIG. 4. In the present configuration, channel-shaped elevations 10 are formed at both edges of the cover element 5, each elevation 10 accommodating the cell connectors 7 arranged on one side of the housings 9. This configuration allows for a particularly flexible arrangement of the cover element 5. In addition, the cell connectors 7 arranged below the cover element 5 can have different shapes and lengths. This configuration ensures that the openings 6 of intact, adjacent energy storage cells 2 are protected when material is released from an opening 6.

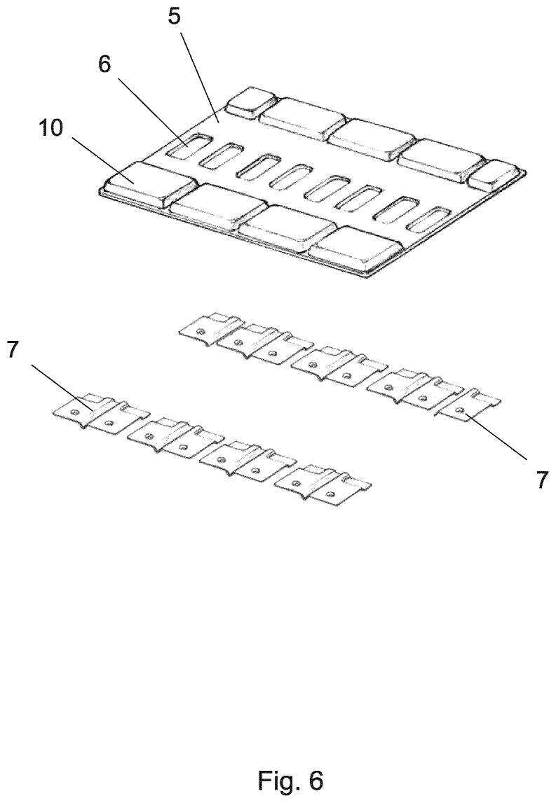

FIG. 6 shows a configuration in which the cover element 5 and the cell connectors 7 form a mountable unit. The cover element 5 is formed directly onto the cell connectors 7 so that the cell connectors 7 are connected to the cover element 5 in a material-locking or a form fitting manner. In the illustration, the cell connectors 7 and the cover element 5 are shown separately from each other as an exploded view for better visibility. Prior to assembly, the cell connectors 7 can be overmolded with the material forming the cover element 5 in an injection molding tool. In an embodiment of the present disclosure, the cell connectors 7 are embedded in the elastic structure of the cover element 4.

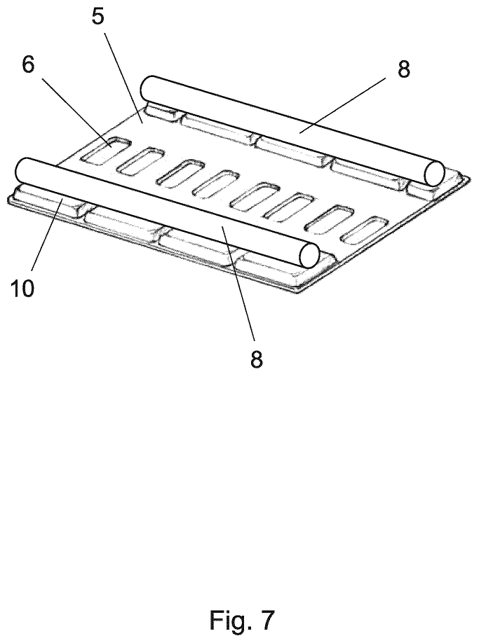

FIG. 7 shows a configuration in which heat sinks 8 are assigned to the cover element 5. In the present configuration, two heat sinks 8 are provided, wherein one heat sink is assigned to each edge region of the cover element 5, wherein the heat sinks 8 are thermally connected to the cell connectors 7 and the electrical terminals 3. This enables particularly effective cooling of the cell connectors 7, the electrical terminals 3, and thus the energy storage cells 2. An elastomeric configuration of the cover element 5 ensures a gap-free contact with both the heat sink 8 and the cell connector 7. The heat sinks 8 can be flowed through by a cooling medium. The heat sinks 8 are preferably assigned to cover elements 5, but can also be integrated into cover elements 5. The configuration may be realized as an overmolded tube for coolant or as heat sinks 8 with an integrated cavity for the coolant flow. The material of the cover element 5 has a thermal conductivity coefficient of at least 0.5 W/(m·K), preferably at least 1.0 W/(m·K).

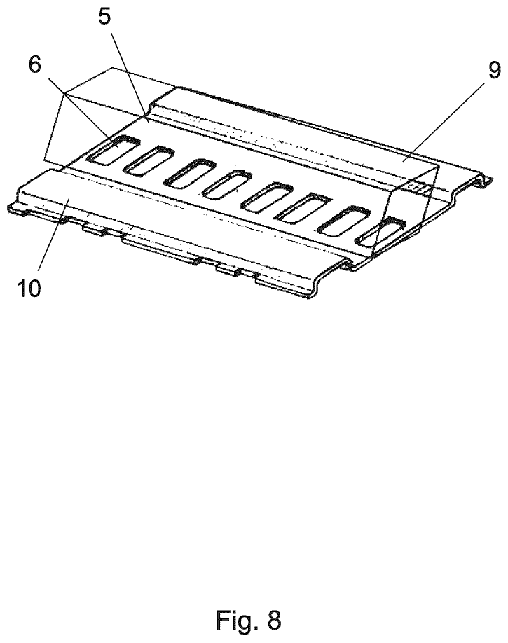

FIG. 8 shows a configuration in which a discharge channel 9 is assigned to the cover element 5. In the event of damage, material released via the safety vents 4 enters the discharge channel 9 and can be removed from the module. The discharge channel 9 is sealed to the cover element 5. In the present embodiment, this is achieved by sealing longitudinal ribs. In an embodiment of the present disclosure, this can be achieved by compression. Since the cover element 5 is arranged between the discharge channel 9 and the cell connectors 7, the discharge channel 9 can also be configured of a metallic material.

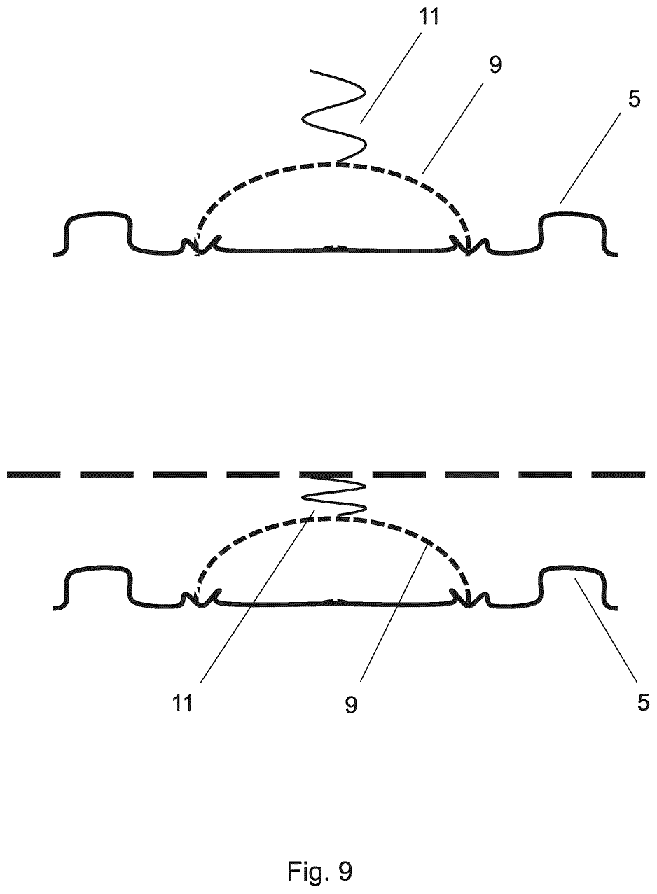

FIG. 9 shows an alternative configuration of the discharge channel 9. The discharge channel 9 contains a pressure element 11, in this case a spring or alternatively a deformable longitudinal profile, which presses the discharge channel 9 against the cover element 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage arrangement comprising a plurality of energy storage cells, each of which has electrical terminals and at least one safety vent, wherein at least one cover element is arranged on the plurality of energy storage cells, wherein the at least one cover element covers the electrical terminals and exhibits openings that are assigned to the safety vents.

2. The energy storage arrangement according to claim 1, wherein adjacent energy storage cells are electrically conductively connected to one another via at least one cell connector, and wherein the at least one cover element covers the cell connectors.

3. The energy storage arrangement according to claim 1, wherein the openings are configured as breakthroughs and are congruent with the safety vents.

4. The energy storage arrangement according to claim 1, wherein the openings each exhibit at least one slit.

5. The energy storage arrangement according to claim 1, wherein the at least one cover element comprises electrically insulating material.

6. The energy storage arrangement according to claim 1, wherein the at least one cover element comprises thermally conductive material.

7. The energy storage arrangement according to claim 1, wherein the at least one cover element comprises polymeric material.

8. The energy storage arrangement according to claim 1, wherein the at least one cover element comprises an elastomeric material.

9. The energy storage arrangement according to claim 1, wherein the at least one cover element comprises a silicone elastomer.

10. The energy storage arrangement according to claim 1, wherein the at least one cover element formed as an injection-molded part or as an extruded part.

11. The energy storage arrangement according to claim 1, wherein the at least one cover element is connected to the plurality of energy storage cells in a material-locking and/or form-fitting manner.

12. The energy storage arrangement according to claim 2, wherein the at least one cover element forms a unit with the cell connectors.

13. The energy storage arrangement according to claim 1, wherein at least one heat sink is assigned to the at least one cover element.

14. The energy storage arrangement according to claim 13, wherein the heat sink is in thermal contact with the cell connectors via the at least one cover element.

15. The energy storage arrangement according to claim 2, wherein a heat sink is assigned to the cell connectors, wherein the cell connectors and the heat sinks are separated by the at least one cover element.

16. The energy storage arrangement according to claim 1, wherein a discharge channel is assigned to the at least one cover element, which removes material released in an event of damage, wherein the discharge channel is sealed by the at least one cover element.

17. The energy storage arrangement according to claim 1, wherein a discharge channel is assigned to the at least one cover element which is pressed against the at least one cover element by a pressure element.
